(19) United States
(12) Patent Application Publication
(10) Pub. No.: US 2016/0137064 A1
(43) Pub. Date: May 19, 2016

(54) TOUCH INPUT DEVICE AND VEHICLE INCLUDING THE SAME

(71) Applicants: HYUNDAI MOTOR COMPANY, Seoul (KR); KIA MOTORS CORPORATION, Seoul (KR); Hyundai Motor Europe Technical Center GmbH, Russelsheim (DE)

(72) Inventors: Jungsang MIN, Seoul (KR); Nae Seung KANG, Siheung-si (KR); Gi Beom HONG, Bucheon-si (KR); Sung Un KIM, Yongin-si (KR); Seo Ho CHOI, Seoul (KR); Sihyun JOO, Seoul (KR); Jeong-Eom LEE, Yongin-si (KR); Werner PETER, Russelsheim (DE); Andy Max PRILL, Russelsheim (DE)

(21) Appl. No.: 14/941,520

(22) Filed: Nov. 13, 2015

(30) Foreign Application Priority Data
Nov. 13, 2014 (KR) 10-2014-0157798
Jul. 8, 2015 (KR) 10-2015-0097152

(51) Int. Cl. B60K 37/06; G06F 3/041; G01C 21/36; G06F 3/01

(52) U.S. Cl. CPC B60K 37/06; G06F 3/017; G06F 3/0414; G01C 21/3664; G06F 2203/04105; B60K 2350/1024; B60K 2350/1052; B60K 2350/352

(57) ABSTRACT

A touch input device includes a touch unit to which a user is able to input a touch gesture, wherein the touch unit includes a concave shape, and gradually deepens from an edge portion toward a central portion.

### CROSS-REFERENCE TO RELATED APPLICATION

This application claims the benefit of priority to Korean Patent Application Nos. 10-2014-0157798 and 10-2015-0097152, filed on Nov. 13, 2014 and Jul. 8, 2015, respectively, with the Korean Intellectual Property Office, the disclosures of which are incorporated herein by reference.

### TECHNICAL FIELD

Embodiments of the present disclosure relate to an input device and a vehicle including the same, and more particularly, to a touch input device to which a gesture can be input and a vehicle including the same.

### BACKGROUND

With the development of telecommunication technology, a variety of electronic devices are being manufactured, and there is a current trend toward emphasizing the designs of these electronic devices together with their operating conveniences for a user. Such a trend leads to diversification of input devices represented by only a keyboard or a key pad.

Input devices are used in various types of display systems that provide information to users, such as portable terminals, laptop computers, smart phones, smart pads, and smart televisions. Recently, with the development of electronic devices, a method of inputting an instruction signal using a touch is used in addition to an input method using a manipulation key, a dial, or so on.

Touch input devices are input devices constituting interfaces between info-communication devices employing various displays and users, and enable interfacing between the info-communication devices and the users when the users directly touch or approach touch pads or touch screens with input tools, such as their fingers or touch pens.

Since anyone can easily use a touch input device simply by touching the touch input device with an input tool, such as his or her finger or a touch pen, touch input devices are being used in various devices, such as automated teller machines (ATM), personal digital assistants (PDA), and cellular phones, and also are being used in many fields, such as banking, government, and tourist and traffic information.

Lately, efforts are being made to apply touch input devices to health or medical products and vehicles. In particular, a touch panel can be used together with a touch screen or separately used in a display system, and thus its utilization is increased. Also, in addition to a function of moving a point using a touch, a function of inputting a gesture is under development in various manners.

In the case of a touch input device for inputting a gesture, efforts are continuously being made to improve a recognition rate of a gesture.

### SUMMARY OF THE DISCLOSURE

Therefore, it is an aspect of the present disclosure to provide a touch input device which provides improved handling or feeling of touch when a user inputs a gesture, and a vehicle including the touch input device.

It is another aspect of the present disclosure to provide a touch input device to which a user can intuitively and accurately input a gesture even when the user does not look at a touch input unit, and a vehicle including the touch input device.

Additional aspects of the disclosure will be set forth in part in the description which follows and, in part, will be obvious from the description, or may be learned by practice of the disclosure.

In accordance with one aspect of the present disclosure, a touch input device includes a touch unit to which a user is able to input a touch gesture, wherein the touch unit includes a concave shape, and gradually deepens from an edge portion toward a central portion or has a uniform depth.

The touch unit may include a curved concave shape whose slope becomes gentler toward the central portion.

The touch unit may have a greatest depth at the central portion.

The touch unit may include a partial spherical shape.

The touch unit may include the central portion and the edge portion which have different slopes or curvatures.

The central portion may be a planar surface, and the edge portion surrounding the central portion may deepen toward the central portion.

The touch unit and the central portion may have a circular shape.

The central portion and the edge portion may receive separate touch signals.

The touch unit may have an oval shape, and a lowest area in the touch unit may be positioned to deviate in any one direction from a center of the touch unit.

The touch unit may include: a gesture input unit positioned at a center; and a swiping input unit positioned along an edge of the gesture input unit, and the gesture input unit and the swiping input unit may receive separate touch signals.

The gesture input unit may have a circular shape, and the swiping input unit may surround a circumferential edge of the gesture input unit.

The swiping input unit may be tilted downward toward the gesture input unit.

A slope of the swiping input unit may be larger than a tangential slope of the gesture input unit adjoining the swiping input unit.

The gesture input unit and the swiping input unit may be formed in one body.

The swiping input unit may include a plurality of gradations formed by engraving or embossing.

The touch unit may be capable of a pressing operation.

The touch unit may be capable of a tilting operation.

The touch unit may be pressed or tilted by a pressure applied by the user to receive a signal.

The gesture input unit may be capable of a tilting operation in four directions, that is, up, down, left and right, or more directions.

The touch input device may further include a button input tool for performing designated functions.

The button input tool may include: a touch button for performing a designated function by a touch of the user; and a pressurizing button for performing a designated function when a position of the pressurizing button is changed by an external force applied by the user.

The touch input device may further include a wrist support tool positioned on one side of the touch unit to support a wrist of the user, and protruding higher than a touch surface of the touch unit.

In accordance with another aspect of the present disclosure, a touch input device includes: a touch unit capable of receiving a touch gesture of a user; and an edge unit configured to surround the touch unit, wherein the touch unit includes a portion lower than a boundary between the touch unit and the edge unit, and gradually deepens from an edge portion toward a central portion or has a uniform depth.

A touch surface of the touch unit may be positioned lower than the boundary between the touch unit and the edge unit.

The touch unit may include a curved portion including a curved concave shape.
An edge portion of the curved portion may have a larger curvature than a central portion.

The touch unit may include the central portion and the edge portion which have different slopes or curvatures, and the edge portion may include a slope portion inclined downward toward the central portion.

The touch unit may have a circular shape, the central portion of the touch unit may include a curved concave shape, and the edge portion may be inclined downward toward the central portion along an edge of the central portion.

The edge portion may include a plurality of gradations formed by engraving or embossing.

The edge unit may include: a touch button for performing a designated function by a touch of the user; and a pressurizing button for performing a designated function when a position of the pressurizing button is changed by an external force applied by the user.

The touch unit may have a circular shape, and a diameter of the touch unit may be selected from within a range of 50 mm to 80 mm.

A depth-to-diameter ratio of the touch unit may be selected from within a range of 0.04 to 0.1.

In accordance with another aspect of the present disclosure, a vehicle includes: the touch input device; a display device; and a control unit configured to operate the display device according to an input signal input to the touch input device.

The display device may be at least one of an audio system, an audio/video navigation (AVN) system, a dashboard, and a head-up display (HUD) device.

The control unit may convert a gesture input to the touch input device into the input signal, and send an operation signal to display an operation indicated by the input signal on the display device.

The touch input device may be installed in a gearbox.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a perspective view of a touch input device according to a first embodiment of the present disclosure;

FIG. 2 is a plan view illustrating manipulation of the touch input device according to the first embodiment of the present disclosure;

FIG. 3 is a cross-sectional view taken along line A-A of FIG. 2;

FIG. 4 is a diagram showing a trace of a finger when a user inputs a gesture in an up-and-down direction;

FIG. 5 is a diagram showing a trace of a finger when a user inputs a gesture in a left-and-right direction;

FIG. 6 is a cross-sectional view of a first modified embodiment of the touch input device according to the first embodiment of the present disclosure;

FIG. 7 is a cross-sectional view of a second modified embodiment of the touch input device according to the first embodiment of the present disclosure;

FIG. 8 is a plan view of a third modified embodiment of the touch input device according to the first embodiment of the present disclosure;

FIG. 9 is a cross-sectional view taken long line B-B of FIG. 8;

FIG. 10 is a perspective view of a touch input device according to a second embodiment of the present disclosure;

FIG. 11 is a plan view of the touch input device according to the second embodiment of the present disclosure;

FIG. 12 is a cross-sectional view taken along line C-C of FIG. 11;

FIGS. 13 to 15 illustrate manipulation of the touch input device according to the second embodiment of the present disclosure in which FIG. 13 is a plan view showing a gesture input, FIG. 14 is a is a plan view showing a swipe input, and FIG. 15 is a plan view showing a pressing input;

FIG. 16 is a cross-sectional view of touch units of a first modified embodiment of the touch input device according to the second embodiment of the present disclosure;

FIG. 17 is a cross-sectional view of touch units of a second modified embodiment of the touch input device according to the second embodiment of the present disclosure;

FIG. 18 is an enlarged view of FIG. 17;

FIG. 19 is a perspective view of the touch input device according to the second embodiment of the present disclosure installed in an exercise machine;

FIG. 20 shows an inner view of a car in which the touch input device according to the second embodiment of the present disclosure is installed; and

FIG. 21 is a perspective view of a gearbox in which the touch input device according to the second embodiment of the present disclosure is installed.

### DETAILED DESCRIPTION

Reference will now be made in detail to the embodiments of the present disclosure, examples of which are illustrated in the accompanying drawings, wherein like reference numerals refer to like elements throughout.

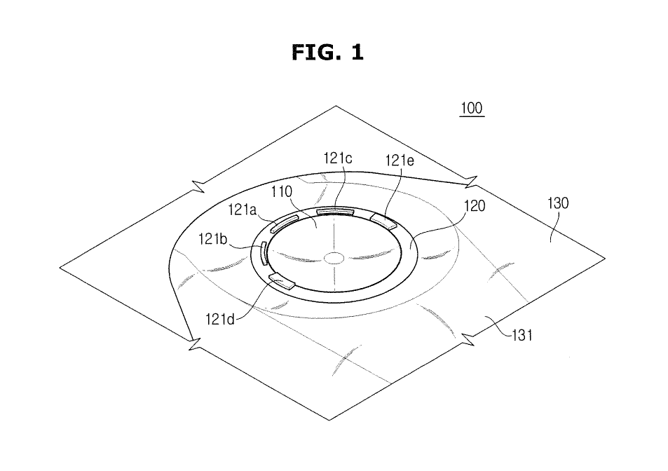

FIG. 1 is a perspective view of a touch input device 100 according to a first embodiment of the present disclosure.

The touch input device 100 according to the first embodiment of the present disclosure includes a touch unit 110 that is installed on an installation surface 130.

The touch unit 110 may be provided as a fixed area for receiving a touch signal of a user. For example, as shown in the drawing, the touch unit 110 may have a circular plan shape. Alternatively, the touch unit 110 can have a variety of planar shapes including an oval shape.

The touch unit 110 may be a touch pad to which a signal is input when the user contacts or approaches the touch pad with a pointer, such as a finger or a touch pen. The user may input a desired instruction or command by inputting a predetermined touch gesture to the touch unit 110.

The touch pad may include a touch film, a touch sheet, etc. including a touch sensor in spite of its name. Also, the touch pad may include a touch panel that is a display device having a touchable screen.

Meanwhile, a case in which the position of the pointer is recognized when the point is close to but not in contact with the touch pad is referred to as a proximity touch, and a case in which the position is recognized when the pointer comes in contact with the touch pad is referred to as a contact touch. Here, the position of a proximity touch may be the position of the pointer vertically corresponding to the touch pad when the pointer approaches the touch pad.

As the touch pad, a resistive touch pad, an optical touch pad, a capacitive touch pad, an ultrasonic touch pad, or a pressure touch pad may be used. In other words, various well-known touch pads may be used.

The touch unit 110 may be installed inside an edge unit 120.

The edge unit 120 denotes a portion surrounding the touch unit 110, and may be provided as a separate member from the touch unit 110. Also, the edge unit 120 may be formed in one body with the installation surface 130 or may be a separate member provided between the installation surface 130 and the touch unit 110. The edge unit 120 can be omitted, and in this case, the touch unit 110 may be installed directly inside the installation surface 130.

In the edge unit 120, key buttons or touch buttons 121 surrounding the touch unit 110 may be positioned. In other words, the user may input a gesture onto the touch unit 110, or input a signal using the buttons 121 provided in the edge unit 120 around the touch unit 110.

The touch input device 100 according to the first embodiment of the present disclosure may further include a wrist support tool 131 positioned under the touch unit 110 to support a wrist of the user. Here, a support surface of the wrist support tool 131 may be positioned higher than a touch surface of the touch unit 110. This prevents the wrist of the user from being bent upward when the user inputs a gesture to the touch unit 110 with his or her finger while the wrist is supported by the wrist support tool 131. Therefore, it is possible to prevent a musculoskeletal disorder which may occur in repeated touch input processes, and to provide comfortable handling.

For example, as shown in the drawing, the wrist support tool 131 may be formed in one body with the installation surface 130 to protrude from the installation surface 130. Alternatively, the wrist support tool 131 may be a separate member provided on the installation surface 130.

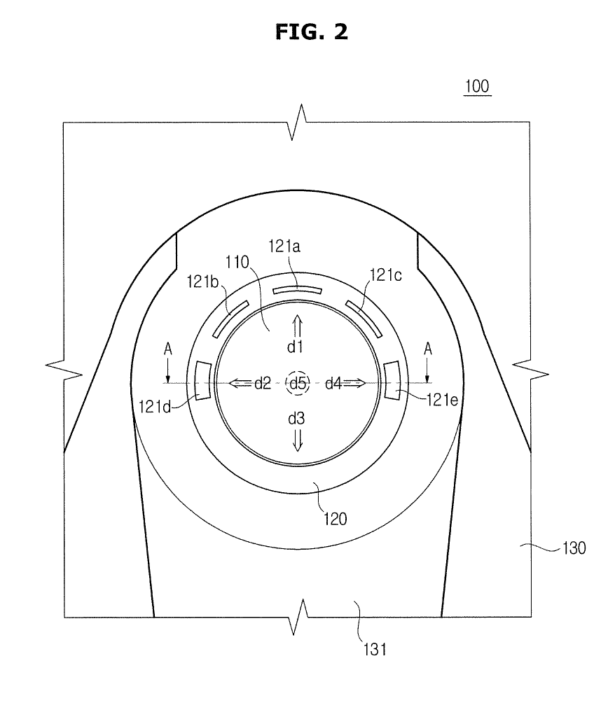

FIG. 2 is a plan view illustrating manipulation of the touch input device 100 according to the first embodiment of the present disclosure.

The touch input device 100 according to the first embodiment of the present disclosure may include a control unit that recognizes a gesture signal input to the touch unit 110 and may analyze the gesture signal to give a command to various devices.

The control unit may move a cursor or a menu on a display unit (not shown) according to the position of the pointer moved on the touch unit 110. In other words, when the pointer moves down, the control unit may move the cursor shown in the display unit in the same direction or may move a preliminarily selected menu from an upper menu to a lower menu.

Also, the control unit may analyze a trace of the pointer, match the trace with a predetermined gesture, and execute a command defined in the matching gesture. A gesture may be input when the pointer makes a flicking, rolling, spinning, or tap motion. In addition to this method, the user may input a gesture using various touch input methods.

Here, flicking denotes a touch input method in which the pointer moves in one direction in contact with the touch unit 110 and then goes out of contact, rolling denotes a touch input method in which the pointer draws a circular arc centered at the center of the touch unit 110, spinning denotes a touch input method in which the pointer draws a circle centered at the center of the touch unit 110, and a tap denotes a touch input method in which the pointer taps the touch unit 110.

The user may also input a gesture using a multi-pointer input method. The multi-pointer input method denotes a method of inputting a gesture while two pointers are simultaneously or sequentially in contact with the touch unit 110. For example, it is possible to input a gesture while two fingers are in contact with the touch unit 110. Using the multi-pointer input method, it is possible to provide various commands or instructions which may be input by the user.

The various touch input methods include input of an arbitrary predetermined gesture as well as input of a gesture of a numeral, a character, a symbol, or so on. For example, the user may input a command by drawing consonants and vowels of the Korean alphabet, letters of the English alphabet, Arabic numerals, signs of the four fundamental arithmetic operations, etc. on the touch unit 110. When the user directly inputs a desired character, numeral, etc. to the touch unit 110 instead of selecting it on the display unit, an input time may be reduced, and a more intuitive interface may be provided.

The touch unit 110 may be capable of a pressing operation or a tilting operation. The user presses or tilts a portion of the touch unit 110 by applying pressure to the touch unit 110 and thereby may input a resultant execution signal. Here, the pressing operation includes a case of pressing the touch unit 110 in parallel with the mounting surface and a case of pressing the touch unit 110 to be tilted to one side. Also, when the touch unit 110 is flexible, it is possible to press only a portion of the touch unit 110.

For example, the touch unit 110 may tilt in at least one direction (d1 to d4) from a central portion d5 thereof. In other words, as shown in FIG. 2, the touch unit 110 may tilt in forward, left, backward, and right directions (d1 to d4). Needless to say, according to an embodiment, the touch unit 110 may tilt in more directions than these directions. Also, when the central portion d5 of the touch unit 110 is pressed, the touch unit 110 may be pressed in parallel with the mounting surface.

The user may press or tilt the touch input device 100 by applying pressure to the touch input device 100, thereby inputting a predetermined instruction or command. For example, the user may select a menu, etc. by pressing the central portion d5 of the touch unit 110, and may move the cursor upward by pressing an upper portion d1 of the touch unit 110.

In addition, the touch input device 100 may further include button input tools 121. The button input tools 121 may be positioned around the touch unit 110. For example, the button input tools 121 may be installed in the edge unit 120. The user may operate the buttons 121 without moving the position of a hand while inputting a gesture, and thus may rapidly give an operation command.

The button input tools 121 include a touch button and a physical button. While the touch button receives a signal through only a touch with the pointer, the physical button is changed in shape by an external physical force to receive a signal. The physical button may include, for example, a clickable button and a tiltable button.

In the drawings, five buttons 121 (121a, 121b, 121c, 121d, and 121e) are shown. For example, the buttons 121 may include a home button 121a for moving to a home menu, a back button 121d for moving from a current screen to a previous screen, an option button 121e for moving to an option menu, and two shortcut buttons 121b and 121c. The shortcut buttons 121b and 121c are intended to designate menus or devices frequently used by the user and directly move to the menus or devices.

Meanwhile, although not shown in the drawings, the touch input device 100 may have various operation-related components embedded therein. In the touch input device 100, a structure for enabling the touch unit 110 to be pressed or tilted in the aforementioned four directions d1 to d4 may be included. Such a structure is not shown in the drawing, but is not difficult to implement using technology that is commonly used in the related technical field.

Also, in the touch input device 100, various semiconductor chips, a printed circuit board (PCB), etc. may be installed. The semiconductor chips may be mounted on the PCB. The semiconductor chips may process information or store data. The semiconductor chips may analyze a predetermined electric signal generated according to an external force applied to the touch input device 100, a gesture recognized by the touch unit 110, or manipulation of a button 121 provided in the touch input device 100, generate a predetermined control signal according to the analyzed content, and then transfer the generated predetermined control signal to a control unit, a display unit, etc. of another device.

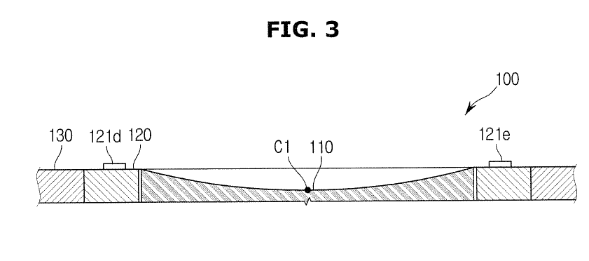

FIG. 3 is a cross-sectional view taken along line A-A of FIG. 2.

The touch unit 110 may include a portion lower than the boundary between the touch unit 110 and the edge unit 120 or the installation surface 130. In other words, the touch surface of the touch unit 110 may be positioned lower than the boundary between the touch unit 110 and the edge unit 120. For example, the touch unit 110 may be inclined downward from the boundary between the touch unit 110 and the edge unit 120, or positioned with a step difference from the boundary. As an example, the touch unit 110 shown in FIG. 3 according to the first embodiment of the present disclosure includes a curved surface unit including a curved concave shape.

Meanwhile, the drawing shows that the touch unit 110 is continuously inclined downward from the boundary between the touch unit 110 and the edge unit 120 without a step. Unlike this, however, the touch unit 110 may be inclined downward with a step difference from the boundary between the touch unit 110 and the edge unit 120.

Since the touch unit 110 includes a portion lower than the boundary between the touch unit 110 and the edge unit 120, the user can recognize the area and the boundary of the touch unit 110 by the sense of touch. When a gesture is made at the central portion of the touch unit 110, a recognition rate may increase. Also, even if similar gestures are input, when the gestures are input at different positions, there is a danger that the gestures will be recognized as different commands. In particular, there is a problem in a case in which the user inputs a gesture without looking at a touch region. If the user can intuitively recognize the touch region and the boundary by the sense of touch when he or she inputs a gesture while looking at the display unit or concentrating on an external situation, this may be advantageous for the user to input the gesture at an accurate position. Therefore, input accuracy of a gesture is improved.

The touch unit 110 may include a concave shape. Here, the concave shape denotes a recessed or depressed shape, and may include a sunken shape with a slope or a step difference as well as a sunken roundish shape.

Also, the touch unit 110 may include a curved concave shape. For example, the touch unit 110 shown in the drawings according to the first embodiment is provided as a curved concave surface having a fixed curvature. In other words, the touch unit 110 may include the shape of a partial inner surface of a sphere. If the curvature of the touch unit 110 is fixed, it is possible to minimize foreign handling when the user inputs a gesture to the touch unit 110.

Further, the touch unit 110 may include a concave shape, and may gradually deepen from the edge portion toward the central portion or have a uniform depth. In other words, the touch unit 110 may not include a convex surface. This is because, when the touch unit 110 includes a convex surface, a trace of a gesture naturally made by the user and the curvature of the touch surface are changed, and those changes may hinder an accurate touch input. The touch unit 110 shown in FIG. 1 has the greatest depth at a center C1, and the depth increases from the edge portion toward the center C1 with a fixed curvature.

Meanwhile, the aforementioned convex surface denotes an overall convex area in the touch region of the touch unit 110 rather than a convex point in a local area. Therefore, the touch unit 110 according to an embodiment of the present disclosure includes a protrusion, such as a small bump formed at the center so that the user can recognize the position of the central portion from the bump, fine wrinkles of concentric circles in the touch unit 110, or so on.

Alternatively, the curved surface of the touch unit 110 may have different curvatures. For example, the touch unit 110 may include a curved concave shape whose slope becomes gentler toward the central portion. In other words, the curvature of an area close to the central portion is small (which denotes a large radius of curvature), and the curvature of an area far from the central portion, that is, the edge portion, may be large (which denotes a small radius of curvature). In this way, by making the curvature of the central portion of the touch unit 110 smaller than the curvature of the edge portion, it is possible to facilitate input of a gesture to the central portion with the pointer. Also, since the curvature of the edge portion is larger than that of the central portion, the user may sense the curvature by touching the edge portion, thereby recognizing the central portion with ease even without looking at the touch unit 110.

In the touch input device 100 according to the first embodiment of the present disclosure, the touch unit 110 includes a curved concave surface, so that the user's feeling of touch (or handling) may be improved when inputting a gesture. The curved surface of the touch unit 110 may be similar to a trace of a finger tip when a person makes a motion, such as a motion of moving a finger while fixing his or her wrist, or a motion of rotating or twisting a wrist with a stretched finger.

In comparison with a generally used planar touch unit, the touch unit 110 including a curved concave surface according to an embodiment of the present disclosure is ergonomic. In other words, the user's touch handling can be improved, and also fatigue of a wrist, etc. can be reduced. In addition, input accuracy can be improved compared to the case of inputting a gesture to the planar touch unit.

The touch unit 110 may have a circular shape. When the touch unit 110 has a circular shape, it is easy to form a curved concave surface. Also, since the touch unit 110 has a circular shape, the user may sense the circular touch region of the touch unit 110 by the sense of touch, and thus can easily input a circular gesture such as rolling or spinning.

In addition, when the touch unit 110 has a curved concave surface, the user may intuitively know a position in the touch unit 110 at which his or her finger is present. Since the touch unit 110 is provided as a curved surface, a slope varies according to points in the touch unit 110. Therefore, the user can intuitively know a position in the touch unit 110 at which his or her finger is present based on a slope felt by the finger.

When the user inputs a gesture to the touch unit 110 while fixing his or her eyes at a spot other than the touch unit 110, such a characteristic helps the user to input the desired gesture and improves input accuracy of the gesture by providing a feedback on a position in the touch unit 110 at which his or her finger is present. For example, when the user feels that the slope of the touch unit 110 is flat through his or her finger, the user may intuitively know that he or she is touching the central portion of the touch unit 110, and intuitively know on which side of the central portion the finger is positioned by sensing the direction of a slope of the touch unit 110 with his or her finger.

Meanwhile, the diameter and the depth of the touch unit 110 may be determined within an ergonomic design range. For example, the diameter of the touch unit 110 may be selected within a range of 50 mm to 80 mm. In consideration of the average finger length of adults, a range in which a finger can naturally move once while the corresponding wrist is fixed may be selected within 80 mm. When the diameter of the touch unit 110 exceeds 80 mm, a motion of the user's hand for drawing a circle along the edge of the touch unit 110 becomes unnatural, and the corresponding wrist is used more than necessary.

On the other hand, when the diameter of the touch unit 110 is smaller than 50 mm, the area of the touch region may be reduced, and a diversity of gestures that can be input may be lost. Also, since a gesture is made in a small area, input errors of gestures increase.

When the touch unit 110 has a sunken substantially round shape (e.g., a partial spherical surface), a depth-to-diameter ratio of the touch unit 110 may be selected within a range of 0.04 to 0.1. The value obtained by dividing the depth of the touch unit 110 by the diameter denotes the degree of bending of a curved surface of the touch unit 110. In other words, the larger the depth-to-diameter ratio of the touch unit 110 having the same diameter, the more concave the shape of the touch unit 110 becomes. On the other hand, the smaller the depth-to-diameter ratio, the more planar the shape of the touch unit 110 becomes.

When the depth-to-diameter ratio of the touch unit 110 is larger than 0.1, the curvature of the concave shape becomes large, and the user feels discomfort upon touching. It is preferable for the concave shape of the touch unit 110 to have the curvature of a curve drawn by a finger tip of the user in a natural finger motion of the user. However, if the depth-to-diameter ratio exceeds 0.1, when the user moves his or her finger along the touch unit 110, artificial handling is felt. Also, when the user unconsciously and naturally moves his or her finger, the finger tip may be taken off from the touch unit 110. In this case, the touch of a gesture is interrupted, and a recognition error occurs.

On the other hand, when the depth-to-diameter ratio of the touch unit 110 is smaller than 0.04, it is difficult for the user to feel a difference in handling in comparison with a planar touch unit.

Meanwhile, a touch pad used in the touch unit 110 provided as a curved surface may recognize a touch using an optical method. For example, an infrared (IR) light-emitting diode (LED) and photodiode array may be disposed on the rear side of the touch unit 110. The IR LED and photodiodes obtain an IR image reflected by the finger, and a control unit extracts a touch point from the obtained image.

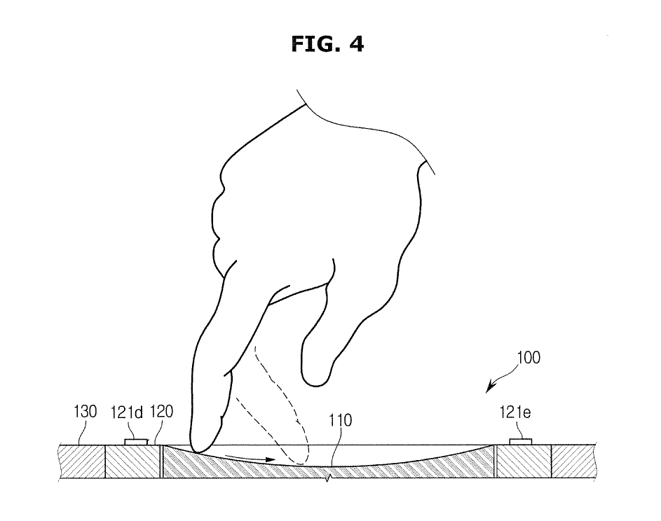

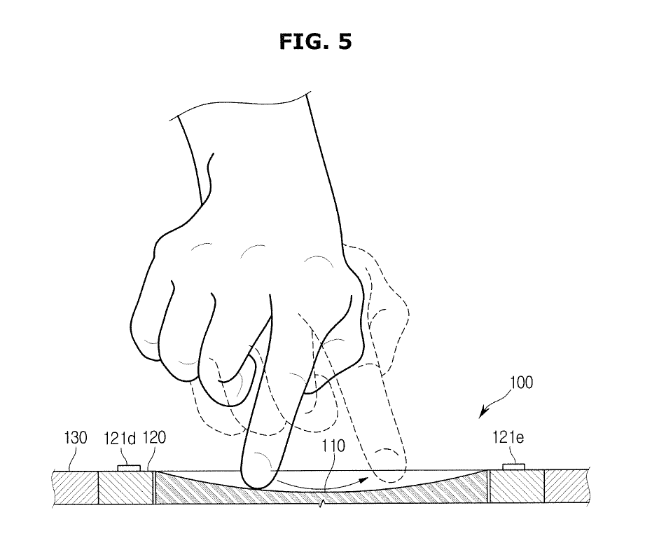

FIG. 4 is a diagram showing a trace of a finger when a user inputs a gesture in an up-and-down direction, and FIG. 5 is a diagram showing a trace of a finger when a user inputs a gesture in a left-and-right direction.

The touch unit 110 according to an embodiment of the present disclosure includes a curved concave surface. Here, the curvature of the touch unit 110 may be determined so that the user feels comfortable when inputting a gesture. Referring to FIG. 4, when moving a finger in an up-and-down direction, the user may input a gesture by only a natural motion of the finger without moving or bending joints other than those of the finger. Likewise, referring to FIG. 5, when moving a finger in a left-and-right direction, the user may input a gesture by only a natural motion of the finger and the wrist without excessively twisting the wrist. In this way, the shape of the touch unit 110 according to an embodiment of the present disclosure is ergonomically designed, so that the user feels less fatigued in spite of long-time use, and skeletal disorders which may be caused in wrists and other joints can be prevented.

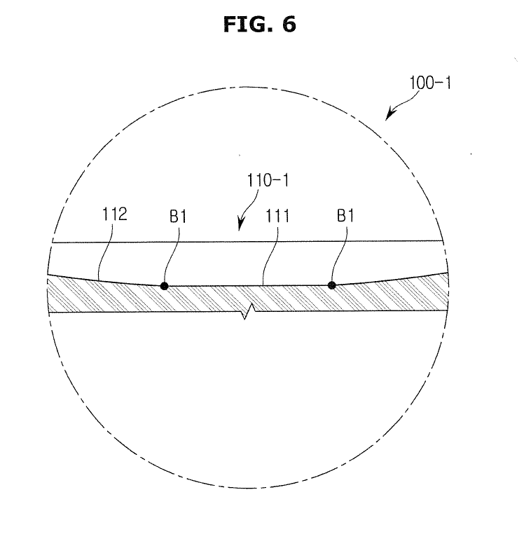

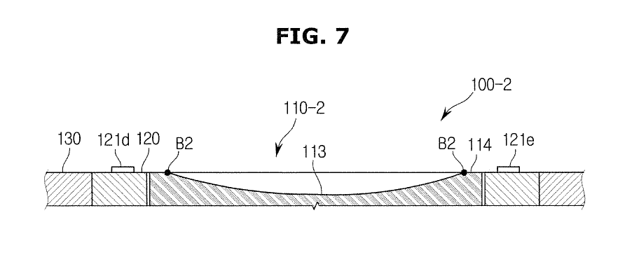

The touch unit 110 according to an embodiment of the present disclosure may include the central portion and the edge portion having different slopes or curvatures. When the touch unit 110 is provided as a flat surface or an inclined surface, the touch unit 110 has a slope, and when the touch unit 110 is provided as a curved surface, the touch unit 110 has a curvature. FIGS. 6 and 7 show different modified embodiments.

FIG. 6 is a cross-sectional view of a first modified embodiment 100-1 of the touch input device according to the first embodiment of the present disclosure.

Although not shown in the drawing, a touch unit 110-1 of the first modified embodiment 100-1 may have a circular shape (see FIG. 2). A central portion 111 of the touch unit 110-1 may have a flat surface, and an edge portion 112 may have a curved concave surface. Here, a boundary B1 between the central portion 111 and the edge portion 112 may also have a circular shape.

When a width ratio of the edge portion 112 to the central portion 111 is diversified, the touch unit 110-1 may bring about different effects. For example, when the width of the central portion 111 is relatively large and the width of the edge portion 112 is relatively small, the central portion 111 provided as a flat surface may be used as a space for inputting a gesture of a character, etc., and the edge portion 112 provided as a curved surface may be used as a space for inputting a circular gesture such as rolling or spinning.

On the other hand, when the width of the central portion 111 is relatively small and the width of the edge portion 112 is relatively large, the edge portion 112 provided as a curved surface may be used as a space for inputting a gesture, and the central portion 111 provided as a flat surface may be used as a mark for notifying the user of the center of the touch unit 110-1.

Meanwhile, touch signals input to the central portion 111 and the edge portion 112 may be distinguished from each other. For example, a touch signal of the central portion 111 may denote a signal for a submenu, and a touch signal of the edge portion may denote a signal for a menu.

FIG. 7 is a cross-sectional view of a second modified embodiment 100-2 of the touch input device according to the first embodiment of the present disclosure.

In the touch unit 110-2 of the second modified embodiment 100-2, a central portion 113 may have a curved concave surface, and an edge portion 114 may have a flat surface. Here, a boundary B2 between the central portion 113 and the edge portion 114 may have a circular shape.

Meanwhile, the central portions 111 and 113 and the edge portions 112 and 114 may have various shapes other than those of the modified embodiments shown in FIGS. 6 and 7. The central portions 111 and 113 and the edge portions 112 and 114 can be divided into two or more steps.

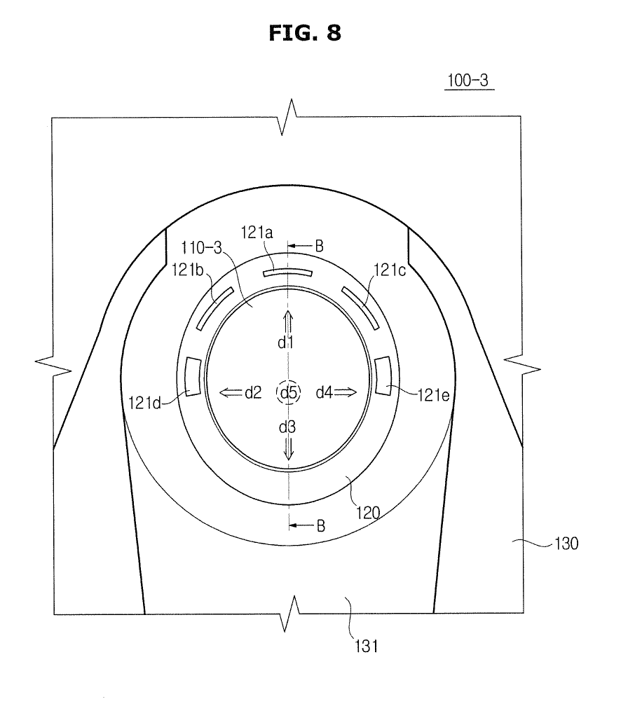

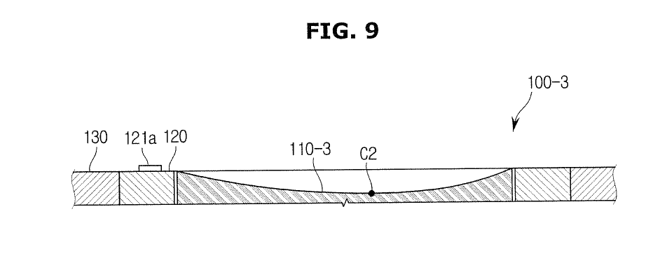

FIG. 8 is a plan view of a third modified embodiment 100-3 of the touch input device according to the first embodiment of the present disclosure, and FIG. 9 is a cross-sectional view taken along line B-B of FIG. 8.

A touch unit 110-3 according to the third modified embodiment 100-3 may have an oval shape. For example, as shown in FIG. 8, an inner diameter in an up-and-down direction may be larger than an inner diameter in a width direction.

A lowest point C2 in the touch unit 110-3 may be positioned to deviate in any one direction from the center. For example, as shown in FIG. 9, the lowest point C2 may be positioned to deviate in a lower direction.

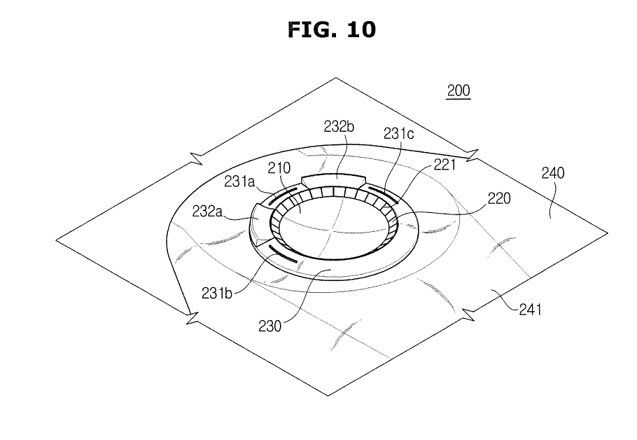

FIG. 10 is a perspective view of a touch input device 200 according to a second embodiment of the present disclosure.

The touch input device 200 according to the second embodiment of the present disclosure includes touch units 210 and 220 that may be touched by a user to receive a gesture, and an edge unit 230 surrounding the touch units 210 and 220.

The touch units 210 and 220 may have a gesture input unit 210 positioned at the central portion, and a swiping input unit 220 positioned along the gesture input unit 210. The swiping input unit 220 denotes a portion to which a swipe gesture may be input, and a swipe denotes an action of inputting a gesture without taking a pointer off a touch pad.

The touch units 210 and 220 may be touch pads to which a signal is input when the user contacts or approaches the touch pads with the pointer, such as a finger or a touch pen. The user may input a desired instruction or command by inputting a predetermined touch gesture to the touch unit 210 or 220.

The touch pads may include a touch film, a touch sheet, etc. including a touch sensor in spite of its name. Also, the touch pads may include a touch panel that is a display device having a touchable screen.

Meanwhile, a case in which the position of the pointer is recognized when the point is close to but not in contact with a touch pad is referred to as a proximity touch, and a case in which the position is recognized when the pointer comes in contact with a touch pad is referred to as a contact touch. Here, the position of a proximity touch may be the position of the pointer vertically corresponding to a touch pad when the pointer approaches the touch pad.

As the touch pads, resistive touch pads, optical touch pads, capacitive touch pads, ultrasonic touch pads, or pressure touch pads may be used. In other words, various well-known touch pads may be used.

The edge unit 230 denotes a portion surrounding the touch units 210 and 220, and may be provided as a separate member from the touch units 210 and 220. In the edge unit 230, pressurizing buttons 232a and 232b and touch buttons 231a, 231b, and 231c surrounding the touch units 210 and 220 may be positioned. In other words, the user may input a gesture on the touch unit 210 or 220, or input a signal using the buttons 231 and 232 provided in the edge unit 230 around the touch units 210 and 220.

The touch input device 200 may further include a wrist support tool 241 positioned under the touch units 210 and 220 to support a wrist of the user. Here, the wrist support tool 241 may be positioned higher than the touch surfaces of the touch units 210 and 220. When the user inputs a gesture to the touch unit 210 or 220 with his or her finger while the wrist is supported by the wrist support tool 241, the wrist of the user is prevented from being bent. Therefore, it is possible to prevent a musculoskeletal disorder in the user and provide comfortable handling.

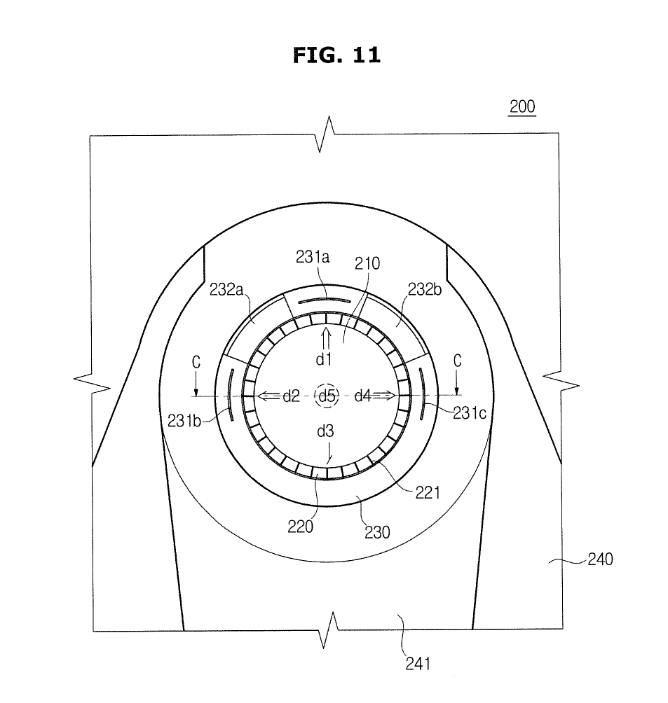

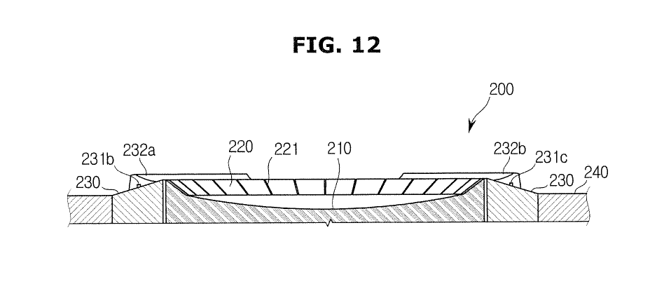

FIG. 11 is a plan view of the touch input device 200 according to the second embodiment of the present disclosure, and FIG. 12 is a cross-sectional view taken along line C-C of FIG. 11.

The touch units 210 and 220 may include portions lower than the boundary between the touch units 210 and 220 and the edge unit 230. In other words, the touch surfaces of the touch units 210 and 220 may be positioned lower than the edge unit 230. For example, the touch units 210 and 220 may be inclined downward from the boundary between the touch units 210 and 220 and the edge unit 230, or positioned with a step difference from the boundary.

Also, since the touch units 210 and 220 are positioned lower than the boundary between the touch units 210 and 220 and the edge unit 230, the user can recognize the areas and the boundary of the touch units 210 and 220 by the sense of touch. When a gesture is made at an intermediate area of the touch unit 210 or 220, a recognition rate may be high. Also, even if similar gestures are input, when the gestures are input at different positions in the touch unit 210 or 220, there is a danger that a control unit will recognize the gestures as different commands. In particular, there is a problem in a case in which the user inputs a gesture without looking at a touch region. If the user can intuitively recognize the touch region and the boundary by the sense of touch when he or she inputs a gesture while looking at a display unit or concentrating on an external situation, this may be advantageous for the user to input the gesture at an accurate position. Therefore, input accuracy of a gesture is improved.

The touch units 210 and 220 may have a gesture input unit 210 positioned at the center and a swiping input unit 220 inclined downward along the edge of the gesture input unit 210. When the touch units 210 and 220 have a circular shape, the gesture input unit 210 may have the shape of a partial inner surface of a sphere, and the swiping input unit 220 may be an inclined surface surrounding the circumference of the gesture input unit 210.

The user may input a swipe gesture along the swiping input unit 220 having a circular shape. For example, the user may input a swipe gesture along the swiping input unit 220 clockwise or counterclockwise. A circular gesture motion, such as rolling or spinning, in the gesture input unit 210 and a gesture motion of rubbing the gesture input unit 210 from left to right are some swipe gestures, but a swipe gesture in embodiments of the present disclosure indicates a gesture input to the swiping input unit 220.

A swipe gesture input to the swiping input unit 220 may be recognized as different gestures when a start point and an end point are changed. In other words, a swipe gesture input to the swiping input unit 220 on the left side of the gesture input unit 210 and the swipe gesture input to the swiping input unit 220 on the right side of the gesture input unit 210 may cause different operations. Also, even when the user contacts one point with his or her finger to input a swipe gesture, if the end point of the gesture is changed, that is, if a position from which the user takes the finger off is changed, the gesture may be recognized as different gestures.

Also, a tap gesture may be input to the swiping input unit 220. In other words, different commands or instructions may be input according to positions in the swiping input unit 220 tapped by the user.

The swiping input unit 220 may include a plurality of gradations 221. The gradations 221 may visually or tactually inform the user of a relative position. For example, the gradations 221 may be formed by engraving or embossing. The respective gradations 221 may be disposed at regular intervals. Therefore, the user may intuitively know the number of gradations 221 which the user's finger passes by during a swipe motion, and thus may precisely adjust the length of a swipe gesture.

As an example, according to the number of gradations 221 which the user's finger passes by during a swipe gesture, a cursor shown in the display unit may move. When various selection characters are continuously disposed in the display unit, a character to be selected may move to one side by one space every time the user's finger passes one gradation 221 while making a swipe motion.

The slope of the swiping input unit 220 according to an embodiment of the present disclosure may be larger than a tangential slope of the gesture input unit 210 at the boundary between the swiping input unit 220 and the gesture input unit 210. The user may intuitively recognize the touch region of the gesture input unit 210 from a slope difference between the gesture input unit 210 and the swiping input unit 220 when inputting a gesture onto the gesture input unit 210.

It is possible not to recognize a touch on the swiping input unit 220 while a gesture is input onto the gesture input unit 210. Therefore, even when the user's finger intrudes the area of the swiping input unit 220 while inputting a gesture onto the gesture input unit 210, the gesture input onto the gesture input unit 210 and a gesture input onto the swiping input unit 220 may not overlap.

The gesture input unit 210 and the swiping input unit 220 may be formed in one body. Separate touch sensors or one touch sensor may be provided for the gesture input unit 210 and the swiping input unit 220. When one touch sensor is provided for the gesture input unit 210 and the swiping input unit 220, the control unit may distinguish between a gesture input signal of the gesture input unit 210 and a gesture input signal of the swiping input unit 220 by distinguishing the touch region of the gesture input unit 210 and the touch region of the swiping input unit 220.

The touch input device 200 may further include button input tools 231 and 232. The button input tools 231 and 232 may be positioned around the touch units 210 and 220. The user may operate the buttons 231 and 232 without changing the position of his or her hand while inputting a gesture, and thus may rapidly give an operation command.

The button input tools 231 and 232 may include touch buttons 231a, 231b, and 231c for performing designated functions by a touch of the user, and pressurizing buttons 232a and 232b for performing designated functions when the positions of the pressurizing buttons 232a and 232b are changed by an external force applied by the user. When the touch buttons 231a, 231b, and 231c are used, a touch sensor may be provided in the button input tools 231 and 232.

The pressurizing buttons 232a and 232b may be provided to slide up or down (in out-of-surface directions) or slide in in-surface directions by the external force. In the latter case, the user may input a signal by pulling or pushing the pressurizing button 232a or 232b. Also, the pressurizing buttons 232a and 232b may operate so that different signals are input by pushing and pulling the pressurizing button 232a or 232b.

In the drawings, five buttons 231 and 232 are shown. For example, the buttons 231 and 232 may include a home button 231a for moving to a home menu, a back button 231b for moving from a current screen to a previous screen, an option button 231c for moving to an option menu, and two shortcut buttons 232a and 232b. The shortcut buttons 232a and 232b are intended to designate menus or devices frequently used by the user and directly move to the menus or devices.

As the button input tools 231 and 232 according to an embodiment of the present disclosure, the touch buttons 231a, 231b, and 231c are positioned in an upper portion and both side portions, and the pressurizing buttons 232a and 232b are positioned between the touch buttons 231a and 231b and between the touch buttons 231a and 231c. In this way, the pressurizing buttons 232a and 232b are positioned between the adjacent touch buttons 231a, 231b, and 231c, and thus it is possible to prevent a mistake of the user operating the touch button 231a, 231b, or 231c in spite of himself or herself.

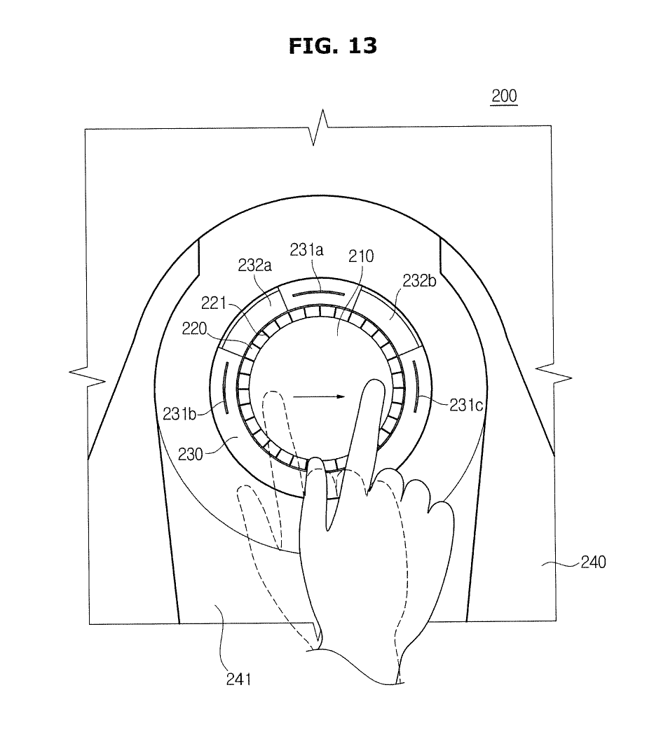

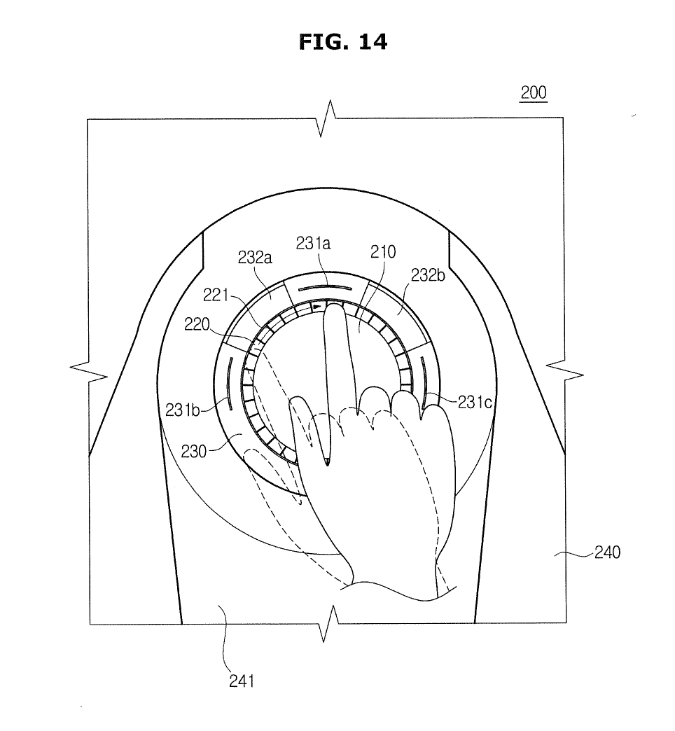

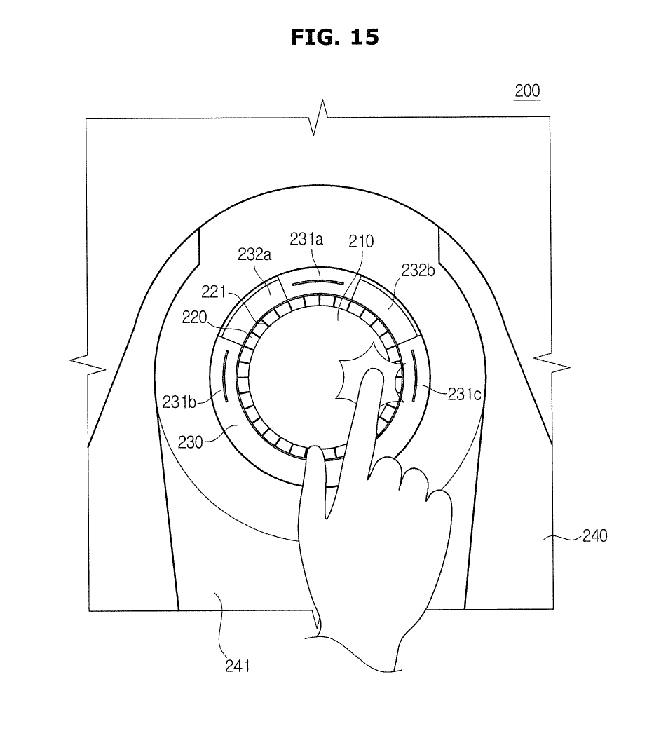

FIGS. 13 to 15 illustrate manipulation of the touch input device 200 according to the second embodiment of the present disclosure. FIG. 13 is a plan view showing a gesture input, FIG. 14 is a plan view showing a swipe input, and FIG. 15 is a plan view showing a pressing input.

Referring to FIG. 13, the user may input an operation command by making a gesture on the gesture input unit 210. FIG. 13 shows a flicking gesture of moving a pointer from left to right. Also, referring to FIG. 14, the user may input an operation command by rubbing the swiping input unit 220. FIG. 14 shows a swipe gesture of putting a pointer into contact with the left side of the swiping input unit 220 and moving the pointer to the upper side along the swiping input unit 220. Also, referring to FIG. 15, the user may input an operation command by pressing the gesture input unit 210. FIG. 15 shows a motion of pressing a right side of the gesture input unit 210.

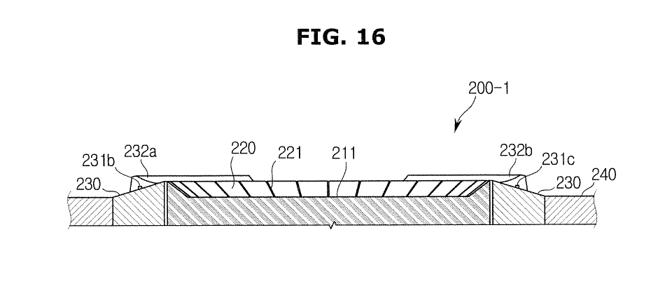

FIG. 16 is a cross-sectional view of touch units 211 and 220 of a first modified embodiment 200-1 of the touch input device according to the second embodiment of the present disclosure.

Referring to FIG. 16, as the touch units 211 and 220 according to the first modified embodiment, a gesture input unit 211 may have a planar shape, and a swiping input unit 220 may be inclined downward. Since the gesture input unit 211 is positioned lower than the boundary between the touch units 211 and 220 and the outside of the touch units 211 and 220, a user may intuitively recognize a touch region.

Also, the swiping input unit 220 is provided, so that the user easily inputs a swipe gesture.

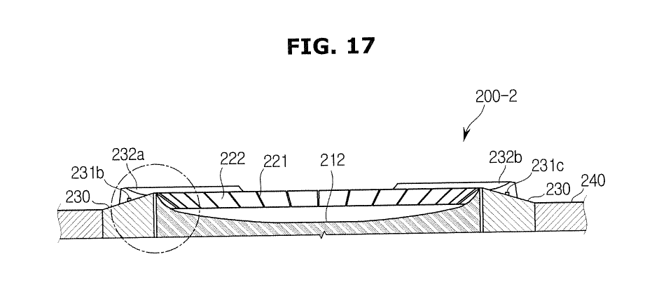

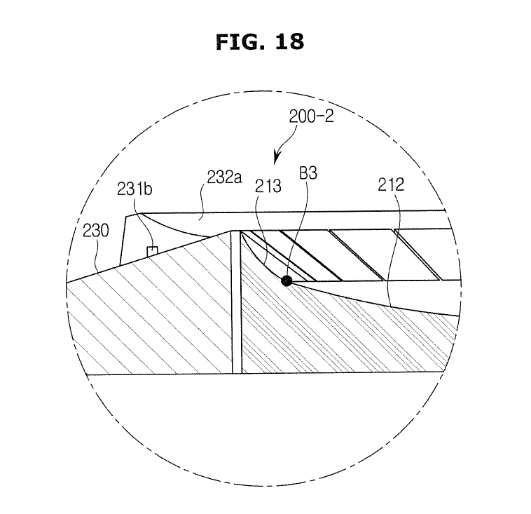

FIG. 17 is a cross-sectional view of touch units 212 and 222 of a second modified embodiment 200-2 of the touch input device according to the second embodiment of the present disclosure, and FIG. 18 is an enlarged view of FIG. 17. Referring to FIG. 17, as the touch units 212 and 222 according to the second modified embodiment of the present disclosure, a gesture input unit 212 and a swiping input unit 222 are formed to be continuous curved surfaces. Here, the curvature of the swiping input unit 222 is larger than the curvature of the gesture input unit 212. By sensing a drastic change in curvature, a user may distinguish between the swiping input unit 222 and the gesture input unit 212 even without looking at the touch units 212 and 222. Meanwhile, at a boundary B3 between the gesture input unit 212 and the swiping input unit 222, the tangential slope of an internal direction and the tangential slope of an external direction differ from each other.

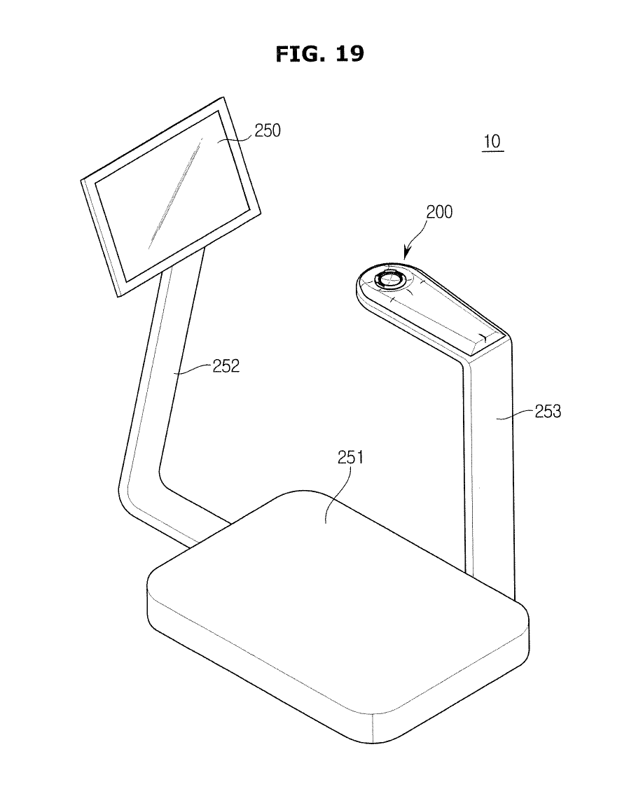

FIG. 19 is a perspective view of the touch input device 200 according to the second embodiment of the present disclosure installed in an exercise machine 10.

The touch input device 200 according to the embodiment of the present disclosure may be installed in the exercise machine 10. Here, the exercise machine 10 may include a medical device. The exercise machine 10 may include a body unit 251 on which a user may stand, a display unit 250, a first connection unit 252 that connects the body unit 251 and the display unit 250, the touch input device 200, and a second connection unit 253 that connects the touch input device 200 and the body unit 251.

The body unit 251 may measure various physical information, including one's weight. The display unit 250 may display various images of information, including the measured physical information. The user may manipulate the touch input device 200 while looking at the display unit 250.

The touch input device 200 according to the embodiment of the present disclosure may be installed in a vehicle 20.

Here, the vehicle 20 denotes various machines that transport a target to be carried, such as a person, an object, or an animal, from an origin to a destination. The vehicle 20 may include a car that travels on a road or a railroad, a ship that moves on the sea or a river, an airplane that flies in the sky using the action of the air, and so on.

Also, a car traveling on a road or a railroad may move in a predetermined direction according to rotation of at least one wheel, and may include, for example, a three- or four-wheel car, construction machinery, a two-wheel car, a motor bicycle, and a train traveling on a railroad.

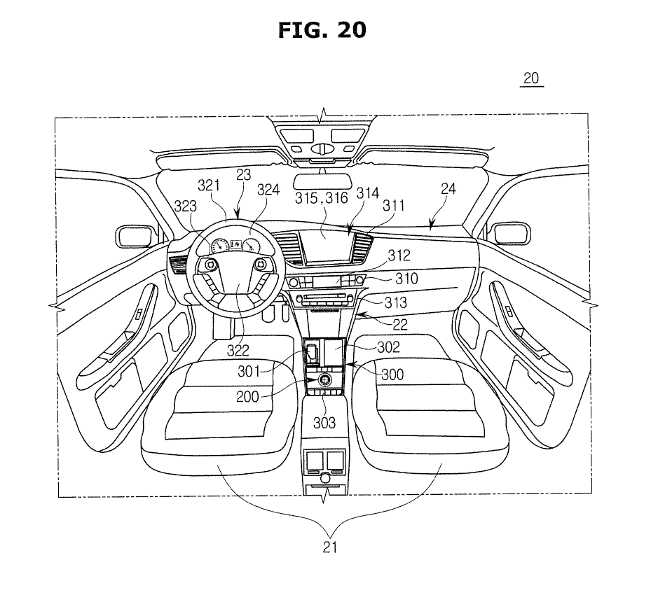

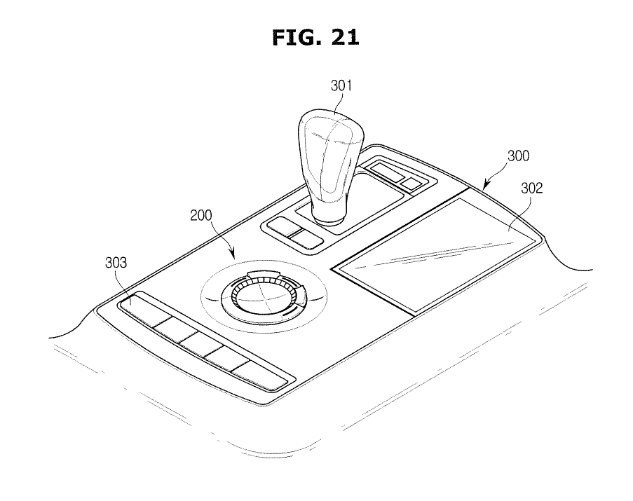

FIG. 20 shows an inner view of a vehicle 20 in which the touch input device 200 according to the second embodiment of the present disclosure is installed, and FIG. 21 is a perspective view of a gearbox 300 in which the touch input device 200 according to the second embodiment of the present disclosure is installed.

Referring to FIG. 20, the vehicle 20 may include seats 21 on which a driver, etc. sit, the gearbox 300, and a dashboard 24 including a center fascia 22, a steering wheel 23, and so on.

In the center fascia 22, an air conditioning system 310, a clock 312, an audio system 313, an audio/video navigation (AVN) system 314, etc. may be installed.

The air conditioning system 310 keeps the inside of the vehicle 20 pleasant by adjusting a temperature, humidity, air quality, and air flow in the vehicle 20. The air conditioning system 310 may include at least one outlet 311 that is installed in the center fascia 22 and intended to discharge air. Buttons, dials, etc. for controlling the air conditioning system 310, etc. may be installed in the center fascia 22. A user, such as a driver, may control the air conditioning system 310 using the buttons disposed in the center fascia 22.

The clock 312 may be provided close to a button or a dial for controlling the air conditioning system 310.

The audio system 313 includes a manipulation panel in which a plurality of buttons for performing functions of the audio system 313 is provided. The audio system 313 may provide a radio mode for providing radio functions and a media mode for playing audio files stored in various storage media.

The AVN system 314 may be embedded in the center fascia 22 or formed to protrude from the dashboard 24. The AVN system 314 may comprehensively perform audio functions, video functions, and navigation functions according to manipulation of the user. The AVN system 314 may include an input unit 315 for receiving a user command for the AVN system 314, and a display unit 316 for displaying a screen related to audio functions, a screen related to video functions, or a screen related to navigation functions. Meanwhile, an element that is common to both the AVN system 314 and the audio system 313 may be omitted from the audio system 313.

The steering wheel 23 is a device for adjusting a traveling direction of the vehicle 20. The steering wheel 23 may include a rim 321 grasped by the driver, and a spoke 322 connected to a steering system of the vehicle 20 and connecting the rim 321 and a hub of a rotation axis for steering. According to an embodiment, a manipulation device 323 for controlling various devices in the vehicle 20, for example, the audio system 313, may be formed in the spoke 322.

The dashboard 24 may further include an instrument panel 324 that notifies the driver of various vehicle information, such as vehicle speed, travel distance, engine revolutions per minute (RPM), the amount of lubrication, a coolant temperature, and various warnings during travel, a glove box for storing various objects, and so on.

The gearbox 300 may be generally installed between a driver's seat and a front passenger seat, and manipulation devices required to be manipulated while the driver drives the vehicle 20 may be installed.

Referring to FIG. 21, in the gearbox 300, a gearshift 301 for changing speed of the vehicle 20, a display unit 302 for controlling the performing of functions of the vehicle 20, and buttons 303 for operating various devices in the vehicle 20 may be installed. Also, the touch input device 200 according to the second embodiment of the present disclosure may be installed.

The touch input device 200 according to the embodiment of the present disclosure may be installed in the gearbox 300 so that the driver can manipulate the touch input device 200 with his or her eyes kept forward during driving. For example, the touch input device 200 may be positioned under the gearshift 301. Alternatively, the touch input device 200 may be installed in the center fascia 22, the front passenger seat, or another seat or area of the vehicle.

The touch input device 200 may be connected to display devices in the vehicle 20, so that various icons, etc. displayed on the display devices may be selected or executed. The display devices installed in the vehicle 20 may be the audio system 313, the AVN system 314, the instrument panel 324, and so on. Also, the display unit 302 may be installed in the gearbox 300 as necessary. The display devices may be connected to a head-up display (HUD) device, a back mirror, or so on.

For example, the touch input device 200 may move a cursor displayed on the display devices, or execute icons. The icons may include a main menu, a selection menu, a setting menu, and so on. Also, through the touch input device 200, it is possible to operate a navigation device, set a running condition of the vehicle 20, or operate peripheral devices of the vehicle 20.

As is apparent from the above description, a touch input unit of a touch input device according to an embodiment of the present disclosure includes a concave (or recessed or depressed) shape and thus can provide improved handling and feeling of touch when a user inputs a gesture. Also, since the shape of the touch input unit is ergonomically designed, even when the user uses the touch input device for a long time, it is possible to prevent damage to a joint of his or her wrist or a dorsum of his or her hand.

Since the touch input unit is formed to be lower than surroundings, the user can intuitively know a touch region without looking at the touch input unit, so that a gesture recognition rate can be improved.

Since the touch input unit includes a curved concave surface, even when the user uses the touch input device without looking at the touch input unit, that is, while looking at a display or looking forward, the user can intuitively know an area of the touch input unit in which his or her finger is present based on a slope felt by the finger.

Therefore, the user can easily input a gesture while looking at a display unit without looking at the touch input unit, and can input a precise gesture to an accurate position, so that a gesture recognition rate can be improved.

In particular, if the touch input device according to an embodiment of the present disclosure is applied to a vehicle, a driver can input an accurate gesture while keeping his or her eyes to the front when the driver manipulates a navigation system, an audio system, etc. at the wheel.

A swiping input unit can be provided around a gesture input unit to serve as a dial that physically rotates. Also, the swiping input unit can recognize various touch gestures, so that various functions improved beyond the dial function can be performed.

Gradations that can be felt by the sense of touch are formed on the swiping input unit, so that the user can intuitively know a swipe angle (or distance). Therefore, by making it possible to input different signals according to swipe angles (or distances), the degree of freedom of manipulation can be improved, and input accuracy can be improved.

Slopes of the gesture input unit and the swiping input unit are made different from each other, so that the user can intuitively distinguish between the gesture input unit and the swiping input unit by a touch.

The touch input unit is pressed in several directions and performs different functions according to pressed directions, so that an instruction can be rapidly performed.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A touch input device comprising a touch unit to which a user is able to input a touch gesture,
wherein the touch unit includes a concave shape, and gradually deepens from an edge portion toward a central portion.

2. The touch input device according to claim 1, wherein the touch unit includes a curved concave shape whose slope becomes gentler toward the central portion.

3. The touch input device according to claim 1, wherein the touch unit has a greatest depth at the central portion.

4. The touch input device according to claim 2, wherein the touch unit includes a partial spherical shape.

5. The touch input device according to claim 1, wherein the touch unit includes the central portion and the edge portion which have different slopes or curvatures.

6. The touch input device according to claim 5, wherein the central portion is a planar surface, and
the edge portion surrounding the central portion deepens toward the central portion.

7. The touch input device according to claim 6, wherein the touch unit and the central portion have a circular shape.

8. The touch input device according to claim 5, wherein the central portion and the edge portion receive separate touch signals.

9. The touch input device according to claim 1, wherein the touch unit has an oval shape, and a lowest area in the touch unit is positioned to deviate in any one direction from a center of the touch unit.

10. The touch input device according to claim 1, wherein the touch unit comprises:
a gesture input unit positioned at a center; and
a swiping input unit positioned along an edge of the gesture input unit, wherein the gesture input unit and the swiping input unit receive separate touch signals.

11. The touch input device according to claim 10, wherein the gesture input unit has a circular shape, and the swiping input unit surrounds a circumferential edge of the gesture input unit.

12. The touch input device according to claim 11, wherein the swiping input unit is tilted downward toward the gesture input unit.

13. The touch input device according to claim 12, wherein a slope of the swiping input unit is larger than a tangential slope of the gesture input unit adjoining the swiping input unit.

14. The touch input device according to claim 10, wherein the gesture input unit and the swiping input unit are formed in one body.

15. The touch input device according to claim 10, wherein the swiping input unit includes a plurality of gradations formed by engraving or embossing.

16. The touch input device according to claim 1, wherein the touch unit is capable of a pressing operation.

17. The touch input device according to claim 1, wherein the touch unit is capable of a tilting operation.

18. The touch input device according to claim 1, wherein the touch unit is pressed or tilted by a pressure applied by the user to receive a signal.

19. The touch input device according to claim 10, wherein the gesture input unit is capable of a tilting operation in four directions, that is, up, down, left and right, directions.

20. The touch input device according to claim 1, further comprising a button input tool for performing designated functions.

21. The touch input device according to claim 20, wherein the button input tool comprises:
a touch button for performing a designated function by a touch of the user; and
a pressurizing button for performing a designated function when a position of the pressurizing button is changed by an external force applied by the user.

22. The touch input device according to claim 1, further comprising a wrist support tool positioned on one side of the touch unit to support a wrist of the user, and protruding higher than a touch surface of the touch unit.

23. A touch input device comprising:
a touch unit capable of receiving a touch gesture of a user; and
an edge unit configured to surround the touch unit,
wherein the touch unit includes a portion lower than a boundary between the touch unit and the edge unit, and gradually deepens from an edge portion toward a central portion.

24. The touch input device according to claim 23, wherein a touch surface of the touch unit is positioned lower than the boundary between the touch unit and the edge unit.

25. The touch input device according to claim 23, wherein the touch unit includes a curved portion including a curved concave shape.

26. The touch input device according to claim 25, wherein an edge portion of the curved portion has a larger curvature than a central portion.

27. The touch input device according to claim 23, wherein the touch unit includes the central portion and the edge portion which have different slopes or curvatures, and the edge portion includes a slope portion inclined downward toward the central portion.

28. The touch input device according to claim 23, wherein the touch unit has a circular shape,
the central portion of the touch unit includes a curved concave shape, and
the edge portion is inclined downward toward the central portion along an edge of the central portion.

29. The touch input device according to claim 28, wherein the edge portion includes a plurality of gradations formed by engraving or embossing.

30. The touch input device according to claim 23, wherein the edge unit comprises:
a touch button for performing a designated function by a touch of the user; and
a pressurizing button for performing a designated function when a position of the pressurizing button is changed by an external force applied by the user.

31. The touch input device according to claim 23, wherein the touch unit has a circular shape, and a diameter of the touch unit is selected from within a range of 50 mm to 80 mm.

32. The touch input device according to claim 31, wherein a depth-to-diameter ratio of the touch unit is selected from within a range of 0.04 to 0.1.

33. A vehicle comprising:
the touch input device according to claim 23;
a display device; and
a control unit for operating the display device according to an input signal input to the touch input device.

34. The vehicle according to claim 33, wherein the display device is included in at least one of an audio system, an audio/video navigation (AVN) system, a dashboard, and a head-up display (HUD) device.

35. The vehicle according to claim 33, wherein the control unit converts a gesture input to the touch input device into the input signal, and sends an operation signal to display an operation indicated by the input signal on the display device.

36. The vehicle according to claim 33, wherein the touch input device is installed in a gearbox.

37. The touch input device according to claim 1, wherein the touch unit includes a uniform depth.
